(19) United States
(12) Patent Application Publication
(10) Pub. No.: US 2025/0221454 A1
(43) Pub. Date: Jul. 10, 2025

(54) POROUS CERAMIC SUBSTRATE HAVING VARYING PORE SIZES AND ATOMIZATION CORE USING SAME

(71) Applicant: HAINING NEW NATAO TECHNOLOGY CO., LTD, Jiaxing (CN)

(72) Inventors: Weili Liu, Jiaxing (CN); Fei Qin, Jiaxing (CN)

(21) Appl. No.: 19/083,447

(22) Filed: Mar. 19, 2025

Related U.S. Application Data
(63) Continuation of application No. PCT/CN2024/143152, filed on Dec. 27, 2024.

(30) Foreign Application Priority Data
Jan. 8, 2024 (CN) 202420048849.5

(51) Int. Cl. A24F 40/44; A24F 40/10; A24F 40/46; H05B 3/22

(52) U.S. Cl. CPC A24F 40/44; A24F 40/10; A24F 40/46; H05B 3/22

(57) ABSTRACT

The present disclosure provides a porous ceramic substrate having varying pore sizes and an atomization core using same. The porous ceramic substrate having varying pore sizes includes multiple groups of ceramic sheets stacked vertically and sintered together; each layer of ceramic sheets is internally provided with bubble-like micropores that are uniformly distributed. The atomization core includes electrode layers and a metal heating layer provided on an atomizing surface of the porous ceramic substrate having varying pore sizes. The present disclosure has the following beneficial effects. The porous ceramic substrate having varying pore sizes has a multi-layered ceramic sheet structure, and the pore sizes of the micropores in each layer exhibit an alternating change or a gradient change. In this way, the present disclosure plays a transition and buffering role on the delivery of an atomization liquid, achieving balance between liquid supply and atomization, and enhancing the atomization experience.

### CROSS REFERENCE TO RELATED APPLICATIONS

The present application is a Continuation application of PCT Application No. PCT/CN2024/143152 filed on Dec. 27, 2024, which claims the benefit of Chinese Patent Application No. 202420048849.5 filed on Jan. 8, 2024. All the above are hereby incorporated by reference in their entirety.

### TECHNICAL FIELD

The present disclosure belongs to the technical field of an atomization core for an electronic cigarette (e-cigarette) atomizer, and particularly relates to a porous ceramic substrate having varying pore sizes and an atomization core using same.

### BACKGROUND

The atomization core of an electronic atomizer is used to heat and atomize a target liquid, namely atomization liquid, into an aerosol or vapor, vapor mist or smoke, for a user to inhale. The atomization liquid can be an e-liquid or a solution including a drug, used for health and medical purposes. The electronic atomizer can be used for an e-cigarette.

At present, the atomization core of the electronic atomizer includes a liquid guiding body made of a porous ceramic substrate. The liquid guiding body is attached with a heating element such as a heating wire, a heating sheet, or a heating film. The heating element is energized to heat and atomize the atomization liquid on the liquid guiding body into an aerosol or vapor, vapor mist or smoke. Currently, the porous ceramic substrate used as the liquid guiding body is mainly prepared by forming a ceramic body through one-time molding and sintering the ceramic body. The porous ceramic substrate has a single micropore structure inside, with little difference in pore sizes. As a result, it has a single liquid guide or supply speed, which does not match the demand of the heating elements for different rates of consuming the atomization liquid according to different power requirements. Due to the imbalance between liquid supply and atomization, the atomization core of the electronic atomizer is prone to dry burning and carbon deposition during atomization as a result of insufficient liquid supply, and is also prone to problems such as exploding and leakage of the e-cigarette liquid caused by too fast liquid supply.

### SUMMARY

### Technical Problem

In response to the shortcomings of the prior art, a technical problem to be solved by the present disclosure is to overcome the deficiencies of the prior art. To this end, the present disclosure provides a porous ceramic substrate having varying pore sizes and an atomization core using same.

### Technical Solutions

The present disclosure adopts a technical solution as follows. A porous ceramic substrate having varying pore sizes includes multiple groups of ceramic sheets stacked vertically and sintered together, where each group of ceramic sheets includes one or more layers of ceramic sheets; each layer of ceramic sheets is internally provided with bubble-like micropores that are uniformly distributed; the micropores in different layers of ceramic sheets in a same group have a same average pore size, while the micropores in different groups of ceramic sheets have different average pore sizes; the multiple groups of ceramic sheets are stacked in an order from bottom to top; the average pore sizes of the micropores in each group of ceramic sheets exhibit an alternating change according to the size or a gradient change from large to small; the micropores in each layer of ceramic sheets have an average pore size of 10-80 μm and a porosity of 35-65%; and each layer of ceramic sheets has a thickness of 0.1-1 mm.

Preferably, there are 2 to 10 groups of ceramic sheets; and each group of ceramic sheets includes 1 to 5 layers of ceramic sheets.

Preferably, there are 2 to 5 groups of ceramic sheets; and each group of ceramic sheets includes 1 to 3 layers of ceramic sheets.

Preferably, there are 3 or 4 groups of ceramic sheets; and each group of ceramic sheets includes 2 layers of ceramic sheets.

Preferably, there are 4 groups of ceramic sheets; each group of ceramic sheets includes 1 layer of ceramic sheets; the average pore sizes of the micropores in the four layers of ceramic sheets exhibit a gradient change from large to small in the stacking order from bottom to top; and the micropores in a first layer of ceramic sheets have a pore size of 40-50 μm, the micropores in a second layer of ceramic sheets have a pore size of 30-40 μm, the micropores in a third layer of ceramic sheets have a pore size of 20-30 μm, and the micropores in a fourth layer of ceramic sheets have a pore size of 10-20 μm.

Preferably, there are 4 groups of ceramic sheets; each group of ceramic sheets includes 1 layer of ceramic sheets; the average pore sizes of the micropores in the four layers of ceramic sheets exhibit an alternating change according to the size in the stacking order from bottom to top; and the micropores in a first layer of ceramic sheets have a pore size of 40-50 μm, the micropores in a second layer of ceramic sheets have a pore size of 30-40 μm, the micropores in a third layer of ceramic sheets have a pore size of 40-50 μm, and the micropores in a fourth layer of ceramic sheets have a pore size of 10-20 μm.

Preferably, there are 3 groups of ceramic sheets; each group of ceramic sheets includes 2 layers of ceramic sheets, and there are a total of 6 layers of ceramic sheets; the average pore sizes of the micropores in the 3 groups of ceramic sheets exhibit a gradient change from large to small in the stacking order from bottom to top; and the micropores in a first group of ceramic sheets have a pore size of 35-50 μm, the micropores in a second group of ceramic sheets have a pore size of 20-35 μm, and the micropores in a third group of ceramic sheets have a pore size of 10-20 μm.

Preferably, there are 4 groups of ceramic sheets; each group of ceramic sheets includes 2 layers of ceramic sheets, and there are a total of 8 layers of ceramic sheets; the average pore sizes of the micropores in the 4 groups of ceramic sheets exhibit a gradient change from large to small in the stacking order from bottom to top; and the micropores in a first group of ceramic sheets have a pore size of 40-50 μm, the micropores in a second group of ceramic sheets have a pore size of 30-40 μm, the micropores in a third group of ceramic sheets have a pore size of 20-30 μm, and the micropores in a fourth group of ceramic sheets have a pore size of 10-20 μm.

The present disclosure adopts another technical solution as follows. A porous ceramic atomization core having varying pore sizes includes the above porous ceramic substrate having varying pore sizes, where the porous ceramic substrate having varying pore sizes includes upper and lower surfaces, with one surface serving as an atomizing surface while the other surface serving as a liquid guiding surface; two ends of the atomizing surface are provided with electrode layers, respectively; the atomizing surface is further provided with a metal heating layer; and the metal heating layer is electrically connected to the electrode layers.

Preferably, of the upper and lower surfaces of the porous ceramic substrate having varying pore sizes, one surface including micropores having a smaller pore size serves as the atomizing surface, while the other surface serves as the liquid guiding surface.

### Beneficial Effects

Different from an existing porous ceramic having a single pore structure, the porous ceramic substrate having varying pore sizes in the present disclosure has a multi-group, multi-layered structure of ceramic sheets. The pore sizes of the micropores in each group or layer of the ceramic sheets are different. In the order of stacking the ceramic sheets from bottom to top, the pore sizes of the micropores in the layers of ceramic sheets exhibit an alternating change according to the size or a gradient change from large to small. There are interlayer interfaces between each two layers of ceramic sheets at a microscopic level. The pore size of micropores in the interlayer interface is between the pore sizes of the micropores in the two layers, which plays a certain transition and buffering role on the delivery of an atomization liquid, facilitating the storage and transport of the atomization liquid. In addition, the stacking method of the multiple layers of ceramic sheets having varying pore sizes can be applied to an atomization core of an e-cigarette. The pore size structure of the micropores in the layers of ceramic sheets in the atomization core is adjustable in a gradient manner according to these layers of ceramic sheets based on different heating methods and different viscosities of e-liquids. By adjusting the porosity and pore sizes layer by layer from the liquid guiding surface to the atomizing surface, the supply of liquid and atomization of the porous ceramic substrate are balanced, achieving the advantages of fast liquid guide and fine atomization, and improving the atomization experience.

### BRIEF DESCRIPTION OF THE DRAWINGS

FIG. 1 is a sectional view of a porous ceramic substrate having varying pore sizes according to a first embodiment of the present disclosure;

FIG. 2 is a sectional view of a porous ceramic substrate having varying pore sizes according to a second embodiment of the present disclosure;

FIG. 3 is a sectional view of a porous ceramic substrate having varying pore sizes according to a third embodiment of the present disclosure;

FIG. 4 is a sectional view of a porous ceramic substrate having varying pore sizes according to a fourth embodiment of the present disclosure;

FIG. 5 is a three-dimensional exploded view of a porous ceramic atomization core having varying pore sizes in a normal position according to fifth and sixth embodiments of the present disclosure; and

FIG. 6 is a three-dimensional exploded view of the porous ceramic atomization core having varying pore sizes in an inverted position according to the fifth and sixth embodiments of the present disclosure.

### DETAILED DESCRIPTION

### Preferred Implementations of the Present Disclosure

To make the objectives, technical solutions, and advantages of the present disclosure clearer, the present disclosure is further described in detail below with reference to the drawings and embodiments. It should be understood that the specific embodiments described herein are merely intended to explain the present disclosure, rather than to limit the present disclosure.

For the convenience of description and better explanation of the present disclosure and its embodiments, the terms or descriptions related to directional or positional relationships such as “top”, “bottom”, “normal”, and “inverted” herein refer to the direction or position in which the device or component is placed in the drawings. They are not intended to pose a limitation that the indicated device, component, or part must have a specific orientation or be constructed and operated in a specific orientation. Therefore, these directional terms will change accordingly in the case of changing the direction and position. In addition, terms such as “first” and “second” are mainly intended to distinguish different devices, components, or parts, and are not intended to indicate or imply the relative importance or absolute order and quantity of the indicated devices, components, or parts. A porous ceramic substrate having varying pore sizes includes multiple groups of ceramic sheets, such as 2 to 10 groups of ceramic sheets, which are stacked vertically and sintered together. Each group of ceramic sheets includes one or more layers, such as 1 to 5 layers of ceramic sheets. Each layer of ceramic sheets is internally provided with bubble-like micropores that are uniformly distributed. The micropores in different layers of ceramic sheets in a same group have a same average pore size, while the micropores in different groups of ceramic sheets have different average pore sizes. The multiple groups of ceramic sheets are stacked from bottom to top. The average pore sizes of the micropores in each group of ceramic sheets exhibit an alternating change according to the size or a gradient change from large to small. The micropores are spherical or nearly spherical bubble-like micropores. There is a relatively small distance between the micropores. Some adjacent micropores are connected by tiny through-holes. Therefore, the entire porous ceramic substrate having varying pore sizes can serve as a liquid guiding body to draw a liquid substance in from one surface of the liquid guiding body and transfer the liquid substance through adsorption, permeation, and flow of the micropores to the other surface of the liquid guiding body to seep out.

In addition, the multiple groups of ceramic sheets above are stacked from bottom to top, and the average pore sizes of the micropores in each group of ceramic sheets exhibit an alternating change according to the size or a gradient change from large to small. In other embodiments, ceramic bodies are stacked according to average particle sizes of an aggregate and/or a pore-forming agent. That is, the ceramic bodies are stacked according to the average particle sizes of the aggregate and/or the pore-forming agent in the ceramic bodies in an order from small to large, or in an alternating order of two large and one small, or two small and one large, or two large and two small. Thus, after the porous ceramic substrate is made, the pore sizes of the micropores in each layer of ceramic sheets are arranged according to the above order.

In the porous ceramic substrate having varying pore sizes in the present disclosure, the micropores in each layer of ceramic sheets have an average pore size of 10-80 μm and a porosity of 35-65%, and each layer of ceramic sheets has a thickness of 0.1-1 mm. Through the pore sizes of the micropores and the layer thickness structure of the ceramic sheets, the porous ceramic substrate having varying pore sizes has a good transfer and connection ability for transferring the liquid substance under an external force such as suction, without too fast circulation. In addition, the porous ceramic substrate having varying pore sizes has a certain balance ability. When there is no external force such as suction, the micropores have a certain tension and can adsorb the liquid substance to prevent its natural flow and leakage. Therefore, the porous ceramic substrate having varying pore sizes in the present disclosure can be used as a liquid guiding body to transfer an atomization liquid.

In the present disclosure, the micropores in each layer of ceramic sheets of the porous ceramic substrate having varying pore sizes have an average pore size of 10-80 μm, including but not limited to any value within 10-80 μm, and/or 10-20 μm, and/or 20-30 μm, and/or 30-40 μm, and/or 40-50 μm, and/or 50-60 μm, and/or 60-70 μm, and/or 70-80 μm, and/or 15-45 μm, and/or 20-40 μm, and/or 35-65 μm, and/or 55-80 μm.

The micropores in each layer of ceramic sheets of the porous ceramic substrate having varying pore sizes have a porosity of 35-65%, including but not limited to any value within 35-65%, and/or 35-40%, and/or 40-45%, and/or 45-50%, and/or 50-55%, and/or 55-60%, and/or 60-65%, and/or 45-60%, and/or 48-56%.

Each layer of ceramic sheets of the porous ceramic substrate having varying pore sizes has a thickness of 0.1-1 mm, including but not limited to any value within 0.1-1 mm, and/or 0.1 mm, and/or 0.2 mm, and/or 0.3 mm, and/or 0.4 mm, and/or 0.5 mm, and/or 0.6 mm, and/or 0.7 mm, and/or 0.8 mm, and/or 0.9 mm, and/or 1 mm, and/or 0.1-0.25 mm, and/or 0.2-0.4 mm, and/or 0.25-0.5 mm, and/or 0.5-0.65 mm, and/or 0.65-0.8 mm, and/or 0.8-1 mm.

An overall thickness of the porous ceramic substrate having varying pore sizes in the embodiment of the present disclosure is generally 1-8 mm.

In order to prepare the porous ceramic substrate having the above parameters and multiple sheets of the present disclosure, when the porous ceramic substrate having multiple sheets is prepared, one or more layers, such as 1 to 5 layers of identical ceramic bodies, are stacked vertically to form 1 group of ceramic bodies. Multiple groups, such as 2 to 10 groups of ceramic bodies are stacked vertically, pressed together, and sintered after binder removal to form the porous ceramic substrate having multiple sheets. After sintering, one layer of the ceramic body forms one layer of the ceramic sheet.

The ceramic body is made of a slurry for ceramic casting through a casting process. The slurry for ceramic casting includes following components by weight: 40-65 parts of a ceramic powder, 30-50 parts of a solvent, 0.1-3 parts of a slurry dispersant, 1-8 parts of a plasticizer, and 1-10 parts of a binder. The ceramic powder includes following components by weight: 25-55 parts of an aggregate, 5-40 parts of a pore-forming agent, 5-19 parts of a sintering aid, and 5-35 parts of a powder dispersant. The aggregates and pore-forming agents of the ceramic bodies in different layers of a same group have a same average particle size, while the aggregates and/or pore-forming agents of the ceramic bodes in different groups have different average particle sizes. The aggregates and/or pore-forming agents in each group of ceramic bodies have different average particle sizes. It means that the aggregates have different average particle sizes, the pore-forming agents have different average particle sizes, or both the aggregates and pore-forming agents have different average particle sizes. The purpose of this design is to make the micropores in different groups of ceramic sheets formed of different groups of ceramic bodies by sintering have different pore sizes.

The aggregate is a main material that forms a skeleton of the porous ceramic substrate having multiple sheets. It includes at least one of the group consisting of kaolin, diatomite, alumina, silicon nitride, silicon carbide, quartz sand, glass sand, clay, feldspar powder, fused quartz, cordierite, and mullite. In the present disclosure, due to the need to produce the micropores in the ceramic substrate, there is a certain requirement for the particle size of the aggregate, and the average particle size of the aggregate is 5-100 μm.

The pore-forming agent is a material that vaporizes and evaporates during sintering to form the micropores in the porous ceramic substrate. It includes at least one of the group consisting of graphite, starch, wood powder, flour, soybean powder, polystyrene microsphere, polymethyl methacrylate microsphere, sucrose, and fiber. In the present disclosure, due to the need to produce the micropores in the ceramic substrate, there is a certain requirement for the particle size of the pore-forming agent, and the average particle size of the pore-forming agent is 5-100 μm.

Different from an existing porous ceramic having a single pore structure, the porous ceramic substrate having varying pore sizes in the present disclosure has a multi-group, multi-layered structure of ceramic sheets. The pore sizes of the micropores in each group or layer of the ceramic sheets are different. In the order of stacking the ceramic sheets from bottom to top, the pore sizes of the micropores in the layers of ceramic sheets exhibit an alternating change from according to the size or a gradient change from large to small. There are interlayer interfaces between each two layers of ceramic sheets at a microscopic level. The pore size of micropores in the interlayer interface is between the pore sizes of the micropores in the two layers, which plays a certain transition and buffering role on the delivery of the atomization liquid, facilitating the storage and transport of the atomization liquid. In addition, the stacking method of the multiple layers of ceramic sheets having varying pore sizes can be applied to an atomization core of an e-cigarette. The pore size structure of the micropores in the layers of ceramic sheets in the atomization core is adjustable in a gradient manner according to these layers of ceramic sheets based on different heating methods and different viscosities of e-liquids. By adjusting the porosity and pore sizes layer by layer from the liquid guiding surface to the atomizing surface, the supply of liquid and atomization of the porous ceramic substrate are balanced, achieving the advantages of fast liquid guide and fine atomization, and improving the atomization experience.

It should be noted that during the preparation of the porous ceramic substrate having multiple sheets of the present disclosure, due to the stacking and pressing of the ceramic bodies, the thickness of each layer of the ceramic body is slightly greater than the thickness of each layer of ceramic sheets after sintering. The porous ceramic substrate having multiple sheets after sintering is actually a whole, with no obvious sign of layering visible from the exterior or cross-section (generally difficult to distinguish with the naked eye). The group number and layer-by-layer analysis of the ceramic sheets herein are only based on grouping and layering according to the pore sizes of the micropores in each group and layer of ceramic sheets.

### Implementations of the Present Disclosure

The present disclosure will be described in detail below in conjunction with specific embodiments.

### Embodiment 1

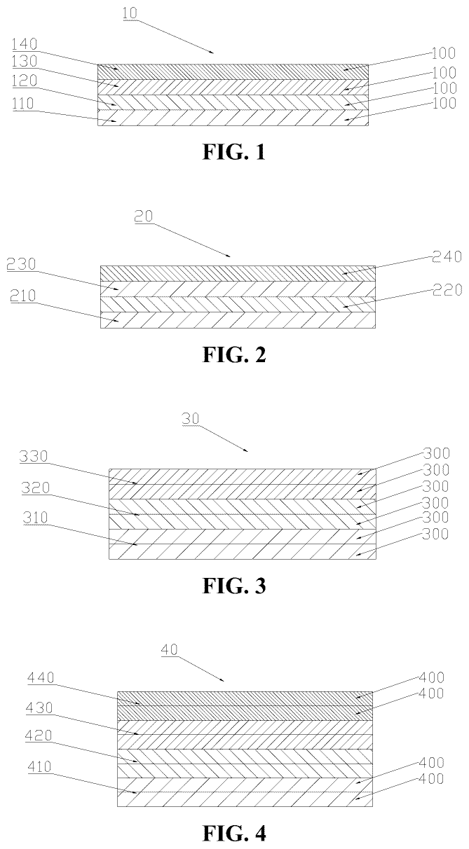

As shown in FIG. 1, a porous ceramic substrate 10 having varying pore sizes in the present disclosure includes 4 groups of ceramic sheets stacked vertically and sintered together. The 4 groups of ceramic sheets include a first group of ceramic sheets 110, a second group of ceramic sheets 120, a third group of ceramic sheets 130, and a fourth group of ceramic sheets 140 from bottom to top. Each group of ceramic sheets includes 1 layer of ceramic sheets 100. Each layer of ceramic sheets 100 is internally provided with bubble-like micropores that are uniformly distributed (not shown in the figure). The micropores in each group or layer of ceramic sheets have different average pore sizes. For these 4 groups of ceramic sheets, in the order from bottom to top, the average pore sizes of the micropores in each group of ceramic sheets exhibit a gradient change from large to small. That is, from the first group of ceramic sheets 110 to the fourth group of ceramic sheets 140, the average pore sizes of the micropores in each group of ceramic sheets exhibit a gradient change from large to small. In the stacking order from bottom to top, the micropores in the first group of ceramic sheets 110 have a pore size of 40-50 μm, the micropores in the second group of ceramic sheets 120 have a pore size of 30-40 μm, the micropores in the third group of ceramic sheets 130 have a pore size of 20-30 μm, and the micropores in the fourth group of ceramic sheets 140 have a pore size of 10-20 μm. In FIG. 1, a shade area with dense diagonal lines represents a smaller pore size, while a shade area with loose diagonal lines represents a larger pore size.

In the porous ceramic substrate having varying pore sizes in this embodiment, the micropores in each layer of ceramic sheets have a porosity of 40-65%, and each layer of ceramic sheets has a thickness of 0.5 mm.

### Embodiment 2

As shown in FIG. 2, a porous ceramic substrate 20 having varying pore sizes in the present disclosure includes 4 groups of ceramic sheets stacked vertically and sintered together. The 4 groups of ceramic sheets include a first group of ceramic sheets 210, a second group of ceramic sheets 220, a third group of ceramic sheets 230, and a fourth group of ceramic sheets 240. Each group of ceramic sheets includes 1 layer of ceramic sheets 210, or 220, or 230, or 240. Each layer of ceramic sheets is internally provided with bubble-like micropores that are uniformly distributed (not shown in the figure). The micropores in each group of ceramic sheets have different average pore sizes. For these 4 groups of ceramic sheets, in the order from bottom to top, the average pore sizes of the micropores in each group of ceramic sheets exhibit an alternating change according to the size. That is, from the first group of ceramic sheets 210 to the fourth group of ceramic sheets 240, the average pore sizes of the micropores in each group of ceramic sheets exhibit an alternating change according to the size. In the stacking order from bottom to top, the micropores in the first group of ceramic sheets 210 have a pore size of 40-50 μm, the micropores in the second group of ceramic sheets 220 have a pore size of 30-40 μm, the micropores in the third group of ceramic sheets 230 have a pore size of 40-50 μm, and the micropores in the fourth group of ceramic sheets 240 have a pore size of 10-20 μm. In FIG. 2, a shade area with dense diagonal lines represents a smaller pore size, while a shade area with loose diagonal lines represents a larger pore size.

In the porous ceramic substrate having varying pore sizes in this embodiment, the micropores in each layer of ceramic sheets have a porosity of 40-65%, and each layer of ceramic sheets has a thickness of 0.5 mm.

### Embodiment 3

As shown in FIG. 3, a porous ceramic substrate 30 having varying pore sizes in this embodiment includes 3 groups of ceramic sheets 310, 320, and 330 stacked vertically and sintered together. Each group of ceramic sheets includes 2 layers of ceramic sheets 300. Each layer of ceramic sheets 300 is internally provided with bubble-like micropores that are uniformly distributed. The micropores in different layers of ceramic sheets in a same group have a same average pore size, while the micropores in different groups of ceramic sheets have different average pore sizes. For these 3 groups of ceramic sheets, in the order from bottom to top, the average pore sizes of the micropores in each group of ceramic sheets exhibit a gradient change from large to small. That is, the 3 groups of ceramic sheets include a first group of ceramic sheets 310, a second group of ceramic sheets 320, and a third group of ceramic sheets 330. Each group of ceramic sheets includes 2 layers of ceramic sheets 300, so there are a total of 6 layers of ceramic sheets. In the order from bottom to top, the micropores in the first group of ceramic sheets 310 have a pore size of 35-50 μm, the micropores in the second group of ceramic sheets 320 have a pore size of 20-35 μm, and the micropores in the third group of ceramic sheets 330 have a pore size of 10-20 μm. In FIG. 3, a shade area with dense diagonal lines represents a smaller pore size, while a shade area with loose diagonal lines represents a larger pore size.

In the porous ceramic substrate having varying pore sizes in this embodiment, the micropores in each layer of ceramic sheets have a porosity of 40-65%, and each layer of ceramic sheets has a thickness of 0.35 mm.

### Embodiment 4

As shown in FIG. 4, a porous ceramic substrate 40 having varying pore sizes in this embodiment includes 4 groups of ceramic sheets 410, 420, 430, and 440 stacked vertically and sintered together. Each group of ceramic sheets includes 2 layers of ceramic sheets 400. Each layer of ceramic sheets 400 is internally provided with bubble-like micropores that are uniformly distributed. The micropores in different layers of ceramic sheets in a same group have a same average pore size, while the micropores in different groups of ceramic sheets have different average pore sizes. For these 4 groups of ceramic sheets, in the order from bottom to top, the average pore sizes of the micropores in each group of ceramic sheets exhibit a gradient change from large to small. That is, the porous ceramic substrate 40 having varying pore sizes in the present disclosure includes 4 groups of ceramic sheets, including a first group of ceramic sheets 410, a second group of ceramic sheets 420, a third group of ceramic sheets 430, and a fourth group of ceramic sheets 440. Each group of ceramic sheets includes 2 layers of ceramic sheets 400, so there are a total of 8 layers of ceramic sheets. In the order from bottom to top, the micropores in the first group of ceramic sheets 410 have a pore size of 40-50 μm, the micropores in the second group of ceramic sheets 420 have a pore size of 30-40 μm, the micropores in the third group of ceramic sheets 430 have a pore size of 20-30 μm, and the micropores in the fourth group of ceramic sheets 440 have a pore size of 10-20 μm. In FIG. 4, a shade area with dense diagonal lines represents a smaller pore size, while a shade area with loose diagonal lines represents a larger pore size.

In the porous ceramic substrate having varying pore sizes in this embodiment, the micropores in each layer of ceramic sheets have a porosity of 40-65%, and each layer of ceramic sheets has a thickness of 0.25 mm.

### Embodiment 5

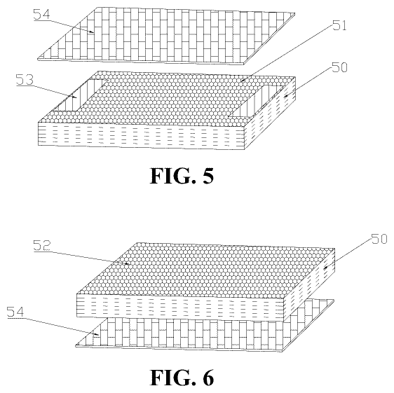

As shown in FIGS. 5 and 6, this embodiment provides a porous ceramic atomization core having varying pore sizes, including a porous ceramic substrate 50 with varying pore sizes serving as a liquid guiding body of the atomization core. On the basis of the porous ceramic substrate 50 having varying pore sizes in the above embodiment, of upper and lower surfaces of the porous ceramic substrate having varying pore sizes, one surface serves as an atomizing surface 51, while the other surface serves as a liquid guiding surface 52. Electrode layers 53 are provided at two ends of the atomizing surface 51, respectively. The electrode layers 53 are prepared by printing metal slurry onto the two ends of the atomizing surface 51 through silk-screen printing, and sintering. The atomizing surface 51 is further provided with a metal heating layer 54. The metal heating layer 54 is prepared by a process of metal sputter coating, or by printing another metal slurry through silk-screen printing and sintering. The metal heating layer 54 covers the electrode layers 53 such that the metal heating layer is electrically connected to the electrode layers. Of the upper and lower surfaces of the porous ceramic substrate having varying pore sizes, either can serve as the liquid guiding surface for introducing a liquid substance, while the other surface serves as the atomizing surface for the liquid substance to seep out. The metal heating layer 54 is provided with micropores or large through-holes, such that the liquid substance seeping out from the atomizing surface 51 can continue to seep out through the metal heating layer or a gaseous substance can evaporate into the air. When the metal heating layer 54 is energized to generate heat, the liquid substance seeping out from the atomizing surface 51 is heated, evaporated, or atomized to form an aerosol or vapor mist, or smoke. The electrode layers 53 are connected to two poles of a power supply so as to provide electrical energy for the metal heating layer 54.

In the present disclosure, the porous ceramic atomization core having varying pore sizes uses the porous ceramic substrate 50 having varying pore sizes as a liquid guiding body. Each layer of ceramic sheets is internally provided with bubble-like micropores that are uniformly distributed. The micropores in a same group of ceramic sheets have a same average pore size, while the micropores in different groups of ceramic sheets have different average pore sizes. These groups of ceramic sheets are stacked from bottom to top. The average pore sizes of the micropores in each group of ceramic sheets exhibit an alternating change according to the size or a gradient change from large to small. The micropores are spherical or nearly spherical bubble-like micropores. There is a relatively small distance between the micropores. Some adjacent micropores are connected by tiny through-holes. Therefore, the entire porous ceramic substrate having varying pore sizes can serve as a liquid guiding body to draw a liquid substance in from one surface of the liquid guiding body and transfer the liquid substance through adsorption, permeation, and flow of the micropores to the other surface of the liquid guiding body to seep out. With reference to the liquid guiding body of the porous ceramic atomization core having varying pore sizes in the present disclosure, through the pore sizes of the micropores and the layer thickness structure of the ceramic sheets, the porous ceramic substrate having varying pore sizes has a good transfer and connection ability for transferring the liquid substance under an external force such as suction, without too fast circulation. In addition, the porous ceramic substrate having varying pore sizes has a certain balance ability. When there is no external force such as suction, the micropores have a certain tension and can adsorb the liquid substance quickly to prevent natural flow and seeping of the liquid substance, thereby preventing leakage. The porous ceramic atomization core having varying pore sizes in the present disclosure can be used for an atomizer of an e-cigarette for heating, evaporating, and atomizing an atomization liquid or e-liquid in a liquid storage chamber of the e-cigarette.

The porous ceramic substrate having varying pore sizes in the present disclosure has a multi-group, multi-layered structure of ceramic sheets. The pore sizes of the micropores in each group or layer of the ceramic sheets are different. In the order of stacking the ceramic sheets from bottom to top, the pore sizes of the micropores in the layers of ceramic sheets exhibit an alternating change according to the size or a gradient change from large to small. There are interlayer interfaces between each two layers of ceramic sheets at a microscopic level. The pore size of micropores in the interlayer interface is between the pore sizes of the micropores in the two layers, which plays a certain transition and buffering role on the delivery of the atomization liquid, facilitating the storage and transport of the atomization liquid. In addition, the stacking method of the multiple layers of ceramic sheets having varying pore sizes can be applied to an atomization core of an e-cigarette. The pore size structure of the micropores in the layers of ceramic sheets in the atomization core is adjustable in a gradient manner according to these layers of ceramic sheets based on different heating methods and different viscosities of e-liquids. By adjusting the porosity and pore sizes layer by layer from the liquid guiding surface to the atomizing surface, the supply of liquid and atomization of the porous ceramic substrate are balanced, achieving the advantages of fast liquid guide and fine atomization, and improving the atomization experience.

In the drawings of the specification, FIG. 5 is a three-dimensional exploded view of the porous ceramic atomization core having multiple sheets in a normal position in this embodiment, and FIG. 6 is a three-dimensional exploded view of the porous ceramic atomization core having multiple sheets in an inverted position in this embodiment. In practical use, the porous ceramic atomization core having multiple sheets of the present disclosure is generally assembled according to the position shown in FIG. 6, such that the atomization liquid can flow from top to bottom by gravity and be transferred to the metal heating layer. The position shown in FIG. 5 is for the convenience of displaying the electrode layers and the metal heating layer in the exploded view of the structure.

### Embodiment 6

As shown in FIGS. 5 and 6, in a porous ceramic atomization core having varying pore sizes in the present disclosure, on the basis of the porous ceramic substrate 50 having varying pore sizes in the above embodiment, of upper and lower surfaces of the porous ceramic substrate having varying pore sizes, one surface including micropores with a smaller pore size forms an atomizing surface 51, while the other surface forms a liquid guiding surface 52. Electrode layers 53 are provided at two ends of the atomizing surface 51, respectively. The electrode layers 53 are prepared by printing metal slurry onto the two ends of the atomizing surface 51 through silk-screen printing, and sintering. The atomizing surface 51 is further provided with a metal heating layer 54. The metal heating layer 54 is prepared by a process of metal sputter coating, or by printing another metal slurry through silk-screen printing and sintering. In this embodiment, the surface including micropores with a smaller pore size serves as the atomizing surface 51, while the other surface serves as the liquid guiding surface 52. In this way, the atomization liquid is easily absorbed by the liquid guiding surface. When the atomization liquid reaches the layer on the atomizing surface, the seeping rate of the atomization liquid is controlled due to the smaller pore size. Thus, the speed of liquid supply is matched to that of atomization to achieve a good dynamic equilibrium, achieving the advantages of fast liquid guide and fine atomization, and improving the atomization experience of e-cigarette users.

The above described are merely preferred embodiments of the present disclosure, and any equivalent changes and modifications made according to the scope of the claims of the present disclosure should fall within the scope covered by the claims of the present disclosure.

1. A porous ceramic substrate having varying pore sizes, comprising multiple groups of ceramic sheets stacked vertically and sintered together, wherein each group of ceramic sheets comprises one or more layers of ceramic sheets; each layer of ceramic sheets is internally provided with bubble-like micropores that are uniformly distributed; the micropores in different layers of ceramic sheets in a same group have a same average pore size, while the micropores in different groups of ceramic sheets have different average pore sizes; the multiple groups of ceramic sheets are stacked in an order from bottom to top; the average pore sizes of the micropores in each group of ceramic sheets exhibit an alternating change according to the size or a gradient change from large to small; the micropores in each layer of ceramic sheets have an average pore size of 10-80 μm and a porosity of 35-65%; and each layer of ceramic sheets has a thickness of 0.1-1 mm.

2. The porous ceramic substrate having varying pore sizes according to claim 1, wherein there are 2 to 10 groups of ceramic sheets; and each group of ceramic sheets comprises 1 to 5 layers of ceramic sheets.

3. The porous ceramic substrate having varying pore sizes according to claim 2, wherein there are 2 to 5 groups of ceramic sheets; and each group of ceramic sheets comprises 1 to 3 layers of ceramic sheets.

4. The porous ceramic substrate having varying pore sizes according to claim 2, wherein there are 3 or 4 groups of ceramic sheets; and each group of ceramic sheets comprises 2 layers of ceramic sheets.

5. The porous ceramic substrate having varying pore sizes according to claim 2, wherein there are 4 groups of ceramic sheets; each group of ceramic sheets comprises 1 layer of ceramic sheets; the average pore sizes of the micropores in the four layers of ceramic sheets exhibit a gradient change from large to small in the stacking order from bottom to top; and wherein the micropores in a first layer of ceramic sheets have a pore size of 40-50 μm, the micropores in a second layer of ceramic sheets have a pore size of 30-40 μm, the micropores in a third layer of ceramic sheets have a pore size of 20-30 μm, and the micropores in a fourth layer of ceramic sheets have a pore size of 10-20 μm.

6. The porous ceramic substrate having varying pore sizes according to claim 2, wherein there are 4 groups of ceramic sheets; each group of ceramic sheets comprises 1 layer of ceramic sheets; the average pore sizes of the micropores in the four layers of ceramic sheets exhibit an alternating change according to the size in the stacking order from bottom to top; and wherein the micropores in a first layer of ceramic sheets have a pore size of 40-50 μm, the micropores in a second layer of ceramic sheets have a pore size of 30-40 μm, the micropores in a third layer of ceramic sheets have a pore size of 40-50 μm, and the micropores in a fourth layer of ceramic sheets have a pore size of 10-20 μm.

7. The porous ceramic substrate having varying pore sizes according to claim 4, wherein there are 3 groups of ceramic sheets; each group of ceramic sheets comprises 2 layers of ceramic sheets, and there are a total of 6 layers of ceramic sheets; the average pore sizes of the micropores in the 3 groups of ceramic sheets exhibit a gradient change from large to small in the stacking order from bottom to top; and wherein the micropores in a first group of ceramic sheets have a pore size of 35-50 μm, the micropores in a second group of ceramic sheets have a pore size of 20-35 μm, and the micropores in a third group of ceramic sheets have a pore size of 10-20 μm.

8. The porous ceramic substrate having varying pore sizes according to claim 4, wherein there are 4 groups of ceramic sheets; each group of ceramic sheets comprises 2 layers of ceramic sheets, and there are a total of 8 layers of ceramic sheets; the average pore sizes of the micropores in the 4 groups of ceramic sheets exhibit a gradient change from large to small in the stacking order from bottom to top; and wherein the micropores in a first group of ceramic sheets have a pore size of 40-50 μm, the micropores in a second group of ceramic sheets have a pore size of 30-40 μm, the micropores in a third group of ceramic sheets have a pore size of 20-30 μm, and the micropores in a fourth group of ceramic sheets have a pore size of 10-20 μm.

9. A porous ceramic atomization core having varying pore sizes, comprising the porous ceramic substrate having varying pore sizes according to claim 1, wherein the porous ceramic substrate having varying pore sizes comprises upper and lower surfaces, wherein one surface serves as an atomizing surface while the other surface serves as a liquid guiding surface; two ends of the atomizing surface are provided with electrode layers, respectively; the atomizing surface is further provided with a metal heating layer; and the metal heating layer is electrically connected to the electrode layers.

10. The porous ceramic atomization core having varying pore sizes according to claim 9, wherein of the upper and lower surfaces of the porous ceramic substrate having varying pore sizes, one surface comprising micropores having a smaller pore size serves as the atomizing surface, while the other surface serves as the liquid guiding surface.

11. A porous ceramic atomization core having varying pore sizes, comprising the porous ceramic substrate having varying pore sizes according to claim 2, wherein the porous ceramic substrate having varying pore sizes comprises upper and lower surfaces, wherein one surface serves as an atomizing surface while the other surface serves as a liquid guiding surface; two ends of the atomizing surface are provided with electrode layers, respectively; the atomizing surface is further provided with a metal heating layer; and the metal heating layer is electrically connected to the electrode layers.

12. A porous ceramic atomization core having varying pore sizes, comprising the porous ceramic substrate having varying pore sizes according to claim 3, wherein the porous ceramic substrate having varying pore sizes comprises upper and lower surfaces, wherein one surface serves as an atomizing surface while the other surface serves as a liquid guiding surface; two ends of the atomizing surface are provided with electrode layers, respectively; the atomizing surface is further provided with a metal heating layer; and the metal heating layer is electrically connected to the electrode layers.

13. A porous ceramic atomization core having varying pore sizes, comprising the porous ceramic substrate having varying pore sizes according to claim 4, wherein the porous ceramic substrate having varying pore sizes comprises upper and lower surfaces, wherein one surface serves as an atomizing surface while the other surface serves as a liquid guiding surface; two ends of the atomizing surface are provided with electrode layers, respectively; the atomizing surface is further provided with a metal heating layer; and the metal heating layer is electrically connected to the electrode layers.

14. A porous ceramic atomization core having varying pore sizes, comprising the porous ceramic substrate having varying pore sizes according to claim 5, wherein the porous ceramic substrate having varying pore sizes comprises upper and lower surfaces, wherein one surface serves as an atomizing surface while the other surface serves as a liquid guiding surface; two ends of the atomizing surface are provided with electrode layers, respectively; the atomizing surface is further provided with a metal heating layer; and the metal heating layer is electrically connected to the electrode layers.

15. A porous ceramic atomization core having varying pore sizes, comprising the porous ceramic substrate having varying pore sizes according to claim 6, wherein the porous ceramic substrate having varying pore sizes comprises upper and lower surfaces, wherein one surface serves as an atomizing surface while the other surface serves as a liquid guiding surface; two ends of the atomizing surface are provided with electrode layers, respectively; the atomizing surface is further provided with a metal heating layer; and the metal heating layer is electrically connected to the electrode layers.

16. A porous ceramic atomization core having varying pore sizes, comprising the porous ceramic substrate having varying pore sizes according to claim 7, wherein the porous ceramic substrate having varying pore sizes comprises upper and lower surfaces, wherein one surface serves as an atomizing surface while the other surface serves as a liquid guiding surface; two ends of the atomizing surface are provided with electrode layers, respectively; the atomizing surface is further provided with a metal heating layer; and the metal heating layer is electrically connected to the electrode layers.

17. A porous ceramic atomization core having varying pore sizes, comprising the porous ceramic substrate having varying pore sizes according to claim 8, wherein the porous ceramic substrate having varying pore sizes comprises upper and lower surfaces, wherein one surface serves as an atomizing surface while the other surface serves as a liquid guiding surface; two ends of the atomizing surface are provided with electrode layers, respectively; the atomizing surface is further provided with a metal heating layer; and the metal heating layer is electrically connected to the electrode layers.
